(19) United States
(12) Patent Application Publication
(10) Pub. No.: US 2022/0405872 A1
(43) Pub. Date: Dec. 22, 2022

(54) SPATIAL DATA UPSAMPLING METHOD, SPATIAL DATA UPSAMPLING APPARATUS AND PROGRAM

(71) Applicant: NIPPON TELEGRAPH AND TELEPHONE CORPORATION, Tokyo (JP)

(72) Inventors: Yusuke TANAKA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/777,194

(22) PCT Filed: Nov. 21, 2019
(86) PCT No.: PCT/JP2019/045662

§ 371 Date: May 16, 2022

(51) Int. Cl. G06Q 50/26; G06N 20/00

(52) U.S. Cl. CPC G06Q 50/26; G06N 20/00

(57) ABSTRACT

A spatial data downscaling method executed by a computer including a memory and a processor, includes acquiring point data where a point in a geographical space and a value at the point are associated with each other and region data in which a region in the geographical space and a value in the region are associated with each other as training data; estimating, with the training data acquired in the acquiring, parameters of a multivariate Gaussian process model represented by a linear mixture of a plurality of latent Gaussian processes; and calculating resolution enhance data in which a region having a finer granularity than the region and a value in the region having the finer granularity are associated with each other from the region data designated by a user with the multivariate Gaussian process model in which the parameters estimated in the estimating have been set.

### TECHNICAL FIELD

The present disclosure relates to a spatial data downscaling method, a spatial data downscaling apparatus, and a program.

### BACKGROUND ART

In recent years, governments and companies have collected and disclosed various types of spatial data (for example, degrees of poverty, degrees of air pollution, numbers of crimes, populations, and traffic volumes) for the purpose of improving urban environments and businesses. The spatial data is data represented by a pair of position information (for example, latitude and longitude, an address, or an area) and some value associated with the position information. Such spatial data has a high collection cost, and it is difficult to secure a sufficient number of samples. Thus, the spatial data is often integrated or aggregated in a region (an address, an area, or the like) having a certain degree of coarse granularity and provided. Hereinafter, spatial data represented by a pair of a point such as latitude and longitude and some value associated with the point is referred to as “point data,” and spatial data represented by a pair of any region (an address, an area, or the like) and some value associated with the region is referred to as “region data.” Further, the region data can be data obtained by integrating or aggregating values included in the point data collected in the region (for example, calculating an average value, a sum value, a representative value, or the like of these values) and setting a result of the integration or aggregation as a value thereof

Here, in order to improve city planning or business more effectively, it is preferable to obtain region data with a resolution as high as possible (that is, region data with granularity as fine as possible). That is, when high-resolution region data can be obtained, for example, areas with high degrees of poverty or areas with high degrees of air pollution can be narrowed down in detail, and thus more detailed measures can be taken against poverty or air pollution. Thus, a problem of conversion of the region data to higher resolution data is important.

For such a problem, a technology for preparing other types of region data with various resolutions separately from target data (that is, low-resolution region data) and training a regression model in which the region data with various resolutions is auxiliary data to predict resolution enhance data obtained by enhancing the resolution of the target data is known (NPL 1). Further, a technology for simultaneously modeling a plurality of types of data based on a multivariate Gaussian process to realize highly accurate prediction for data with a small number of samples is known, although the technology is not a technology for region data (NPL 2).

### CITATION LIST

### Non Patent Literature

NPL 1: Y. Tanaka, T. Iwata, T. Tanaka, T. Kurashima, M. Okawa, and H. Toda. Refining coarse-grained spatial data using auxiliary spatial data sets with various granularities. In AAAI, pages 5091-5100, 2019.

NPL 2: Y. W. Teh, M. Seeger, and M. I. Jordan. Semiparametric latent factor models. In AISTATS, pages 333-340, 2005.

### SUMMARY OF THE INVENTION

### Technical Problem

However, in the related art described in NPL 1 above, accuracy of resolution enhancement may be low due to the following three problems.

The first problem is that region data represented by a pair of a region and a value associated with the region is treated as region data represented by a pair of a centroid of the region and a value associated with the centroid. This means that a spatial correlation between regions is replaced with a spatial correlation between centroids of the regions. Thus, for example, when a shape of the region is peculiar (for example, an elongated region), an erroneous evaluation of the spatial correlation may be made.

The second problem is that low-resolution auxiliary data cannot be fully utilized. In the related art, the auxiliary data is spatially interpolated by Gaussian process regression and aligned with a target resolution, and then a regression model with target data is trained while reliability of a predicted value obtained for this spatial interpolation is taken into account. In this case, the low-resolution auxiliary data tends to have low reliability, and even when the auxiliary data is useful for prediction of the resolution enhance data, the auxiliary data may be ignored in a training process.

The third problem is that auxiliary data is limited to the same region. For example, when a degree of poverty in New York City is used as target data, it is necessary to use other types of region data (a degree of air pollution, the number of crimes, or the like) in the same New York City as the auxiliary data. Thus, it is necessary to obtain many other types of region data different from the target data, but the region data is not always available.

On the other hand, the related art described in NPL 2 above can perform highly accurate prediction even on data with a small number of samples, but the data to be handled is point data. Thus, the related art cannot handle region data or handle both region data and point data.

An embodiment of the present disclosure has been made in view of the above points, and an object of the present disclosure is to enhance a resolution of spatial data with high accuracy.

### Means for Solving the Problem

In order to achieve the above object, a spatial data downscaling method according to the present embodiment includes, at a computer, an acquisition procedure of acquiring, by the computer, point data where a point in a geographical space and a value at the point are associated with each other and region data in which a region in the geographical space and a value in the region are associated with each other as training data; an estimation procedure of, with the training data acquired in the acquisition procedure, estimating parameters of a multivariate Gaussian process model represented by a linear mixture of a plurality of latent Gaussian processes; and a calculation procedure of calculating resolution enhance data in which a region having a finer granularity than the region and a value in the region having the finer granularity are associated with each other from the region data designated by a user with the multivariate Gaussian process model in which the parameters estimated in the estimation procedure have been set.

### Effects of the Invention

It is possible to enhance a resolution of spatial data with high accuracy.

### BRIEF DESCRIPTION OF DRAWINGS

FIG. 1 is a diagram illustrating an example of an overall configuration of a spatial data downscaling apparatus according to the present embodiment.

FIG. 2 is a diagram illustrating an example of a hardware configuration of a spatial data downscaling apparatus according to the present embodiment.

FIG. 3 is a flowchart illustrating an example of parameter estimation processing according to the present embodiment.

FIG. 4 is a flowchart illustrating an example of spatial data resolution enhancing processing according to the present embodiment.

FIG. 5 is a diagram illustrating an example of a spatial data resolution enhance screen.

### DESCRIPTION OF EMBODIMENTS

Hereinafter, embodiments of the present disclosure will be described. In the present embodiment, a spatial data downscaling apparatus 10 capable of enhancing resolution of spatial data with high accuracy will be described.

Here, the spatial data downscaling apparatus 10 according to the present embodiment can estimate unknown quantities (parameters) of a multivariate Gaussian process model that takes a spatial correlation between a point and a point, between a point and a region, and between a region and a region into account when spatial data including point data and region data is given. Thus, the spatial data downscaling apparatus 10 according to the present embodiment can enhance the resolution of spatial data of a target with high accuracy using the multivariate Gaussian process model in which the estimated parameters have been used.

Further, the spatial data downscaling apparatus 10 according to the present embodiment can estimate the parameters of the multivariate Gaussian process model even when spatial data in different spaces (for example, spatial data in a plurality of cities) is given. Thus, the spatial data downscaling apparatus 10 according to the present embodiment can utilize spatial data of other cities to estimate the parameters, for example, even when the number of types of spatial data in a certain city is small.

As described above, the spatial data refers to data represented by a pair of position information (for example, latitude and longitude, an address, and an area) and some value associated with the position information. Further, when the position information is a point such as latitude and longitude (that is, when the spatial data is represented by a pair of a point and some value associated with the point), the spatial data is also represented as point data. On the other hand, when the position information is any region with a geospatial extent (that is, when the spatial data is represented by a pair of a region and some value associated with the region), the spatial data is also referred to as region data. The region data can also be said to be spatial data in which some values are integrated in any region having a certain geospatial extent.

Further, enhancing the resolution of spatial data means, with region data represented by a pair of a certain granularity region and a value associated with the region, calculating the spatial data represented by a pair of a finer granularity region and a value associated with the region. For example, enhancing the resolution of the spatial data means, with region data representing a population in a certain prefecture. calculating region data representing a population in each city in the prefecture.

In the following embodiment, a case in which the parameters of the multivariate Gaussian process model are estimated mainly assuming that a plurality of types of point data and region data in a certain city are given, and the resolution of a target type of region data is enhanced will be described. Further, in this description, a case in which the parameters of the multivariate Gaussian process model are estimated when a plurality of types of point data and region data in a plurality of cities are given will also be described. The type of spatial data (point data and region data) is a type of information represented by the value associated with the point or region, and examples thereof include a degree of poverty, a degree of air pollution, a number of crimes, a population, and a traffic volume.

Overall Configuration

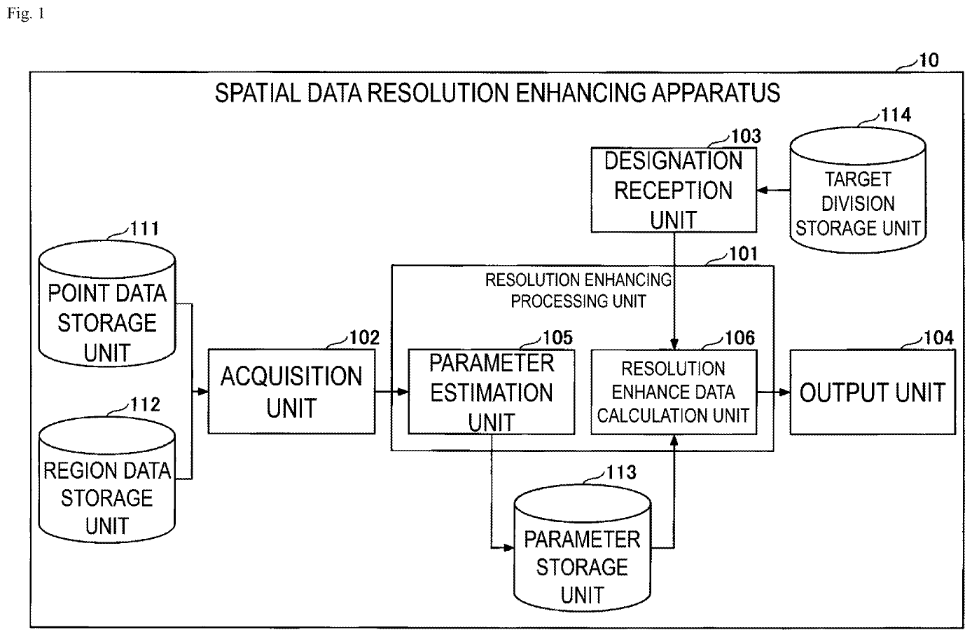

First, an overall configuration of the spatial data downscaling apparatus 10 according to the present embodiment will be described with reference to FIG. 1. FIG. 1 is a diagram illustrating an example of the overall configuration of the spatial data downscaling apparatus 10 according to the present embodiment.

As illustrated in FIG. 1, the spatial data downscaling apparatus 10 according to the present embodiment includes a resolution enhancing processing unit 101, an acquisition unit 102, an operation reception unit 103, and an output unit 104. Further, the spatial data downscaling apparatus 10 according to the present embodiment includes a point data storage unit 111, a region data storage unit 112, a parameter storage unit 113, and a target division storage unit 114.

The point data storage unit 111 stores a plurality of items of point data. The point data stored in the point data storage unit 111 includes a plurality of types of point data.

Here, a set representing an entire input space is set as X ⊂ R (R: the set of all real numbers) and x ∈ X is set as an input variable. For example, X corresponds to the entire city and x corresponds to latitude and longitude. s=1, . . . , S₀ is an argument indicating a type of point data, and n=1, . . . , Nₛ is an argument indicating the number of items of point data of type s (that is, the number of sample points). Further, an n-th sample point of the point data of the type s is x_{s,n}, and the n-th point data of the type s is represented as a set (x_{s,n}, y_{s,n}) of the sample point x_{s,n} and the value y_{s,n} ∈ R. Thus, the point data stored in the point data storage unit 111 is {(x_{s,n}, y_{s,n})|s=1, . . . , S₀; n=1, . . . , Nₛ}. (x_{s,n}, y_{s,n}) means that an n-th observation y_{s,n} of the type s has been obtained at the point x_{s,n}.

The region data storage unit 112 stores a plurality of items of region data. A plurality of types of region data are included in the region data stored in the region data storage unit 112.

Here, s=S₀+1, . . . , S is an argument indicating a type of region data, and Pₛ is an argument indicating division of the region data of type s. The division is a division when a specific geographical space is divided into a plurality of geographical regions, and is, for example, a division of a city by an address or area. Further, |Pₛ| indicates the number of regions included in the division Pₛ. An n-th region is R_{s,n} ∈ Pₛ for an argument n=1, . . . , |Pₛ| indicating the region. Further, the n-th region data of the type s is represented by a set (R_{s,n}, y_{s,n}) of the region R_{s,n} and the value y_{s,n} ∈ R. Thus, the region data stored in the region data storage unit 112 is {(R_{s,n}, y_{s,n})|s=S₀+1, . . . , S; n=1, . . . , |Pₛ|}. (R_{s,n}, y_{s,n}) means that an n-th observation y_{s,n} of the type s has been obtained in the region R_{s,n}.

The parameter storage unit 113 stores parameters (parameters of the multivariate Gaussian process model) estimated by a parameter estimation unit 105 that will be described below. That is, trained parameters of the multivariate Gaussian process model are stored in the parameter storage unit 113. As will be described below, the parameters to be estimated are a spatial scale parameter, a mixing coefficient, a residual variance parameter, and a noise variance parameter.

The target division storage unit 114 stores a target division P^{target} representing division after the enhance in the resolution. Further, one region included in the target division P^{target} is represented R^{target}. Here, any target division P^{target} can be used. For example, it is conceivable that the target division P^{target} is, for example, division by an address, area, or the like, or division by a mesh having a size randomly set by a user.

The resolution enhancing processing unit 101 performs estimation of the parameters of the multivariate Gaussian process model and calculation of resolution enhance data obtained by enhancing the resolution of a target type of region data.

The acquisition unit 102 acquires the point data and the region data from the point data storage unit 111 and the region data storage unit 112 as training data that is used for parameter estimation of the multivariate Gaussian process model.

The operation reception unit 103 receives a user operation for designating a target type of region data and a target division (that is, the target division P^{target}). A resolution of the target type of region data (that is, a granularity of the region of each item of region data of the type) is coarser than that of the target division P^{target}.

The output unit 104 outputs resolution enhance data to a predetermined output destination. The output destination can be any output destination; as examples, display on a display, printing with a printer, sound wave output from a speaker, transmission to an external device connected via a communication network, or the like can be considered.

Here, the resolution enhancing processing unit 101 includes the parameter estimation unit 105 and a resolution enhance data calculation unit 106.

The parameter estimation unit 105 estimates, with the point data and the region data acquired by the acquisition unit 102, the parameters (the spatial scale parameter, the mixing coefficient, the residual variance parameter, and the noise variance parameter) of the multivariate Gaussian process model. Hereinafter, the multivariate Gaussian process model and a method for estimating the parameters thereof will be described.

First, formulation of a multivariate Gaussian process model represented by a linear mixture of a plurality of latent Gaussian processes is performed. L independent Gaussian processes are defined as:

[Math. 1]

gₗ(x)˜ [symbol] (0, γₗ(x, x′)), l=1, . . . , L (1)

Here, γₗ(x, x′): X×X→R is a correlation function of a first Gaussian process, and any function can be used. In the present embodiment,

$$\begin{matrix}[ Math . 2 ] & \\ {γ}_{l} ( x , {x}^{′} ) = exp ( - \frac{1}{2 {β}_{l}^{2}} {‖ x - {x}^{′} ‖}^{2} ) & ( 2 )\end{matrix}$$

is used as this correlation function. Here, βₗ is a spatial scale parameter of the first correlation function. A total number of types of point data and region data (in other words, the number of data sets for each type) is S. For s=1, . . . , S₀, S₀+1, . . . , S, fₛ(x) is a noiseless latent Gaussian process for s-th spatial data (that is, the point data of the type s when s=1, . . . , S₀, and the region data of the type s when s=S₀+1, . . . , S). An S variate Gaussian process

f(x)=(fₗ(x), . . . , f_{S}(x))^{τ} [Math. 3]

is a linear mixture of L independent Gaussian processes, and is represented as

[Math. 4]

f(x)=Wg(x)+n(x) (3)

Here,

g(x)=(gₗ(x), . . . , g_{L}(x))^{τ} [Math. 5]

is represented, W is a mixed matrix of S×L, and w_{s,l} ∈ R that is an (s, l) element represents a mixing coefficient. Further, n(x) is a Gaussian process having an average 0 of an S variate, and is represented as

[Math. 6]

n(x)˜ [symbol] (0, Λ(x, x′)) (4)

Here,

0 [Math. 7]

is an S dimensional vector with all elements of 0, and Λ(x, x′) is

[Math. 8]

Λ(x, x′)=diag(λ₁(x, x′), . . . , λ_{S}(x, x′)) (5)

λₛ(x, x′): X×X→R is a correlation function for the s-th spatial data, and any function can be used. For simplicity in the present embodiment, with a Dirac delta function δ(⋅)

[Math. 9]

λₛ(x, x′)=λₛ²δ(x−x′) (6)

is obtained. λₛ² is a residual variance parameter for an s-th Gaussian process. g(x) in Equation (3) above can be integrated out, and as a result, the S variate Gaussian process can be written as

[Math. 10]

f(x)˜ [symbol] (0, K(x, x′)) (7)

Here, K(x, x′): X×X→R^{S×S} represents a correlation matrix.

[Math. 11]

K(x, x′)=WΓ(x, x′)W^{τ}+Λ(x, x′) (8)

is obtained. Here, Γ(x, x′)=diag(γₗ(x, x′), . . . , γ_{L}(x, x′)). Further, a (s, s′) element of K(x, x′) is given as

$$\begin{matrix}[ Math . 12 ] & \\ {k}_{s , {s}^{′}} ( x , {x}^{′} ) = {δ}_{s , {s}^{′}} {λ}_{s} ( x , {x}^{′} ) + {\sum }_{l = 1}^{L} {𝓌}_{s , I} {w}_{{s}^{′} , I} {γ}_{I} ( x , {x}^{′} ) . & ( 9 )\end{matrix}$$

Here, δ⋅,⋅ is a Kronecker delta function, and δ_{A, B}=1 is output when A=B, and δ_{A, B}=0 is output otherwise.

Then, a value of the region data is represented by a realization value of the Gaussian distribution having an integrated value of the Gaussian process in the region (that is, the region associated with this value) as an average, and a value of the point data is represented by the realization value of the Gaussian distribution having a value of the Gaussian process at the point (that is, a point associated with this value) as an average. An Nₛ dimensional observation vector generated from the s-th Gaussian process for s=1, . . . , S₀ is

yₛ=(y_{s,l}, . . . , yₛ,Nₛ)^{τ}. [Math. 13]

Further, a |Pₛ| dimensional observation vector generated from the s-th Gaussian process for s=S₀+1, . . . , S is

yₛ=(y_{s,l}, . . . , yₛ, [symbol] ₛ|)^{τ}. [Math. 14]

Observation vectors generated from S Gaussian processes are collectively represented as

$$\begin{matrix}[ Math . 15 ] & \\ y = ( \begin{matrix}{y}_{1} \\ ⋮ \\ {y}_{{S}_{0}} \\ {y}_{{S}_{0 + 1}} \\ ⋮ \\ {y}_{S}\end{matrix} ) . & ( 10 )\end{matrix}$$

It is assumed that y follows a multidimensional Gaussian distribution

[Math. 16]

y|f(x)˜ [symbol] (y|∫ₓA(x)f(x)dx,Σ) (11)

### Here,

N=Σₛ₌₁^{S}^{₀}Nₛ+Σ_{s=S}_{₀}₊₁| [symbol] |, [Math. 17]

and A(x): x→R^{N×S} is

[Math. 18]

A(x)=diag(a₁(x), . . . , a_{S}_{₀}(x), a_{S}_{₀}₊₁(x), . . . , a_{S}(x)) (12)

When s=1, . . . , S₀,

aₛ(x)=(a_{s,1}(x), . . . , a_{s,N}_{ₛ}(x))^{τ} [Math. 19]

and when s=S₀+1, . . . , S,

aₛ(x)=(a_{s,1}(x), . . . , [symbol] (x))^{τ}. [Math. 20]

Any a_{s,n}(x) can be used, and a method of integrating in each region can be changed using a method of setting a_{s,n}(x). In the present embodiment, a case in which an observation at a point is obtained when s=1, . . . , S₀, and a result of region-averaging in each region R_{s,n} is obtained as an observation when s=S₀+1, . . . , S is considered. In this case, a_{s,n}(x) can be written as

$$\begin{matrix}[ Math . 21 ] & \\ {a}_{s , n} ( x ) = \{ \begin{matrix}( x = {x}_{s , n} ) & if s = 1 , … , {S}_{0} \\ \frac{( x ∈ {ℛ}_{s , n} )}{{\int }_{𝒳} ( {x}^{′} ∈ {ℛ}_{s , n} ) {dx}^{′}} & if s = {S}_{0} + 1 , … , S\end{matrix} . & ( 13 )\end{matrix}$$

### Here,

[symbol] (●) [Math. 22]

is an indicator function, and when C is true,

[symbol]

(C)=1 [Math. 23]

is output, and otherwise,

[symbol]

(C)=0 [Math. 24]

is output. Further,

$$\begin{matrix}[ Math . 25 ] & \\ \sum = ( \begin{matrix}{σ}_{1}^{2} I & O \\ O & {σ}_{2}^{2} I \\ ⋮ & ⋮ \\ O & O\end{matrix} \begin{matrix}⋯ \\ ⋯ \\ ⋱ \\ …\end{matrix} \begin{matrix}O \\ O \\ ⋮ \\ {σ}_{S}^{2} I\end{matrix} ) , & ( 14 )\end{matrix}$$

and σₛ² is a noise variance parameter of the s-th Gaussian process. Here, I is an identity matrix, and O is a matrix having 0 as elements. Parameters to be estimated by the parameter estimation unit 105 are a spatial scale parameter β={βₗ|l=1, . . . , L}, a mixing matrix W (that is, a mixing coefficient {w_{s,l},|s=1, . . . , S, l=1, . . . , L}) which is an element thereof), a residual variance parameter Λ={λₛ|s=1, . . . , S}, and a noise variance parameter Σ.

Next, a method of training (estimating) various parameters (the spatial scale parameter, the mixing coefficient, the residual variance parameter, and the noise variance parameter) using maximum likelihood estimation will be described. When the observation y is given, by integrating out f(x), a marginal likelihood can be written as

[Math. 26]

p(y)= [symbol] (y|0, C) (15)

Here, C is an N×N correlation matrix, and can be written as

$$\begin{matrix}[ Math . 40 ] & & & \\ & C = & \int {\int }_{𝒳 \times 𝒳} A ( x ) K ( x , {x}^{′} ) {A ( {x}^{′} )}^{T} {dxdx}^{′} + \sum & ( 16 ) \\ & = & ( \begin{matrix}{C}_{1 , 1} & {C}_{1 , 2} & … & {C}_{l , S} \\ {C}_{2 , 1} & {C}_{2 , 2} & … & {C}_{2 , S} \\ ⋮ & ⋮ & ⋱ & ⋮ \\ {C}_{S , 1} & {C}_{S , 2} & … & {C}_{S , S}\end{matrix} ) . & ( 17 )\end{matrix}$$

### C_{s,s′} is

[Math. 28]

C_{s,s′}=∫∫_{x×x}k_{s,s′}(x, x′)aₛ(x)a_{s′}(x′)^{τ}dxdx′+δ_{s,s′}σₛI (18)

Because it is difficult to analytically calculate a regional integration in Equation (18) above, discrete approximation is performed to calculate the regional integration in the present embodiment. First, an input space X is divided into sufficiently fine grids, and a set of grid points included in the regions R_{s,n} is set as

[symbol]

_{s,n}. [Math. 29]

Thus, each component of C_{s,s′} can be approximated to

$$\begin{matrix}[ Math . 30 ] & \\ {C}_{s , {s}^{′}} ( n , {n}^{′} ) \approx \{ \begin{matrix}{k}_{s , {s}^{′} ( {x}_{s} {,}_{n} , {x}_{{s}^{′}} {,}_{{n}^{′}} ) + {δ}_{s} , {s}^{′} {σ}_{s}} & if s = 1 , … , {S}_{0} ; {s}^{′} = 1 , … , {S}_{0} \\ \frac{1}{\vert {𝒢}_{{s}^{′} , {n}^{′}} \vert} {\sum }_{j ∈ {𝒢s}^{′} , {n}^{′}} {k}_{s , {s}^{′} ( {x}_{s , n} , j )} & if s = 1 , … , {S}_{0} ; {s}^{′} = {S}_{0} + 1 , … , S \\ \frac{1}{\vert {𝒢}_{s , n} \vert} {\sum }_{i ∈ 𝒢s , n} {k}_{s , {s}^{′} ( i , {x}_{s , n} )} & if s = {S}_{0} + 1 , … , S ; {s}^{′} = 1 , … , {S}_{0} \\ \frac{1}{\vert {𝒢}_{s , n} \vert} \frac{1}{\vert {𝒢}_{{s}^{′} , {n}^{′}} \vert} {\sum }_{i ∈ {𝒢}_{s , n}} {\sum }_{j ∈ {𝒢s}^{′} , {n}^{′}} {k}_{s , {s}^{′}} ( i , j ) + {δ}_{s , {s}^{′}} {σ}_{s} & if s = {S}_{0} + 1 , … , S ; {s}^{′} = {S}_{0} + 1 , … , S\end{matrix} . & ( 19 )\end{matrix}$$

The first row of Equation (19) above represents “covariance between a point and a point,” the second and third rows represent “covariance between a point and a region,” and the fourth row represents “covariance between a region and a region.” By taking a logarithm of the marginal likelihood shown Equation (15) to extract only terms regarding the parameters to be estimated,

$$\begin{matrix}[ Math . 31 ] & \\ log p ( y \vert W , β , Λ , Σ ) ∝ - \frac{1}{2} {y}^{T} {C}^{- 1} y - \frac{1}{2} log ( det ( C ) ) & ( 20 )\end{matrix}$$

is obtained. By maximizing Equation (20) above, maximum likelihood estimation solutions for various parameters can be obtained. An optimization problem for maximizing Equation (20) above can be solved by using, for example, a Broyden-Fletcher-Goldfarb-Shanno (BFGS) method. For the BFGS method, for example, a reference “D. C. Liu and J. Nocedal. On the limited memory BFGS method for large scale optimization. Mathematical Programming, 45 (1-3): 503-528, 1989,” can be referred to.

A parameter estimation method in a case in which a plurality of types of point data and region data in a plurality of cities are given will be described here. Hereafter, it is assumed that there are V types of cities. In this case, it is assumed that the point data and the region data in each city follow a conditionally independent probability distribution when a common latent Gaussian process {gₗ(x)|l=1, . . . , L} and the mixing matrix W are given. Thus, the marginal likelihood when a plurality of types of point data and region data in a plurality of cities are given can be written as

$$\begin{matrix}[ Math . 32 ] & \\ p ( {y}^{( 1 )} , {y}^{( 2 )} , … , {y}^{( V )} ) = {\prod }_{v = 1}^{V} 𝒩 ( {y}^{( v 〉} \vert 0 , {C}^{( v )} ) . & ( 21 )\end{matrix}$$

Here, y^{(v)} is an observation vector in a city of type v, and C^{(v)} is a correlation matrix for the city of type v. By maximizing Equation (21) above in substantially the same procedure as in the case of one city, maximum likelihood estimation solutions for various parameters can be obtained.

Further, the resolution enhance data calculation unit 106, with the type of region data designated by the user operation received by the operation reception unit 103 and the target division P^{target}, calculates the resolution enhance data obtained by enhancing the resolution of the region data of this type into the target division P^{target}. Hereinafter, a method of calculating the resolution enhance data will be described.

First, a post-process of the S variate Gaussian process f(x) is derived, in which f(x) is the S variate Gaussian process in which various parameters estimated by the parameter estimation unit 105 have been set. This post-process f*(x) can be written as

[Math. 33]

f*(x)˜ [symbol] (m*(x), K*(x, x′)) (22)

Here, m*: X→R^{S} represents an average vector, and K*(x, x′): X×X→R^{S×S} represents a correlation matrix.

Further, H(x): X→R^{N×S} is put as

$$\begin{matrix}[ Math . 34 ] & & & \\ & H ( x ) = & {\int }_{X} A ( {x}^{′} ) K ( {x}^{′} , x ) {dx}^{′} & ( 23 ) \\ & = & ( \begin{matrix}{h}_{1 , 1} ( x ) & {h}_{1 , 2} ( x ) \\ {h}_{2 , 1} ( x ) & {h}_{2 , 2} ( x ) \\ ⋮ & ⋮ \\ {h}_{S , 1} ( x ) & {h}_{S , 2} ( x )\end{matrix} \begin{matrix}⋯ \\ ⋯ \\ ⋱ \\ ⋯\end{matrix} \begin{matrix}{h}_{1 , S} ( x ) \\ {h}_{2 , S} ( x ) \\ ⋮ \\ {h}_{S , S} ( x )\end{matrix} ) . & ( 24 )\end{matrix}$$

### Here,

[Math. 35]

h_{s,s′}(x)=∫ₓaₛ(x′)k_{s,s′}(x′, x)dx′ (25)

Because it is difficult to analytically calculate a regional integration in Equation (25) above, a discrete approximation is performed as in Equation (19) above. Thus, a set of grid points, with

[symbol]

_{s,n} [Math. 36]

an n-th element of h_{s,s′}(x) can be calculated as

$$\begin{matrix}[ Math . 37 ] & \\ \{ \begin{matrix}{k}_{s , {s}^{′}} ( {x}_{s , n} , x ) & if s = 1 , … , {S}_{0} \\ \frac{1}{\vert {s , n}_{} \vert} {\sum }_{i ∈ {s , n}_{}} {k}_{s , {s}^{′}} ( i , x ) & if s = {S}_{0} + 1 , … , S\end{matrix} . & ( 26 )\end{matrix}$$

Thus, by using H(x), m*(x) and K*(x, x′) are expressed as

[Math. 38]

m*(x)=m(x)+H(x)^{τ}C⁻¹(y−μ), (27)

K*(x, x′)=K(x, x′)−H(x)^{τ}C⁻¹H(x) (28)

In this case, the resolution enhance data to be calculated is obtained by integrating a posterior average shown in Equation (27) above in each region in the target division P^{target}. Now consider calculating a predicted value in the region R^{target} included in the target division P^{target} (that is, a value associated with this region R^{target}) with an argument indicating the type (that is, the target type of region data) designated by the user operation received by the operation reception unit 103 as s. Denoting an s-th element of a posterior average m*(x) as mₛ*(x), a predicted value to be obtained is

$$\begin{matrix}\\ & [ Math . 39 ] \\ {\int }_{χ} {a}^{t a r g e t} ( x ) {m}_{s}^{*} ( x ) dx & & \\ & \approx & {\sum }_{i ∈ {𝒢}^{t a r g e t}} {a}^{t a r g e t} ( i ) {m}_{s}^{*} ( i ) & ( 29 ) \\ & \approx & \frac{1}{\vert {𝒢}^{t a r g e t} \vert} {\sum }_{i ∈ {𝒢}^{t a r g e t}} {m}_{s}^{*} ( i ) . & ( 30 )\end{matrix}$$

Here, a^{target}(x) is

$$\begin{matrix}[ Math . 40 ] & \\ {a}^{t a r g e t} ( x ) = \frac{( x ∈ {ℛ}^{t a r g e t} )}{{\int }_{𝒳} ( {x}^{′} ∈ {ℛ}^{t a r g e t} ) {dx}^{′}} . & ( 31 )\end{matrix}$$

For the regional integration in Equation (29) above, discrete approximation is performed, and a set of grid points included in the region R^{target} is obtained as

[symbol]

^{target} [Math. 41]

By repeating the calculation process of Equations (29) to (31) above for each region R^{target} included in the target division P^{target}, desired resolution enhance data can be obtained.

Hardware Configuration

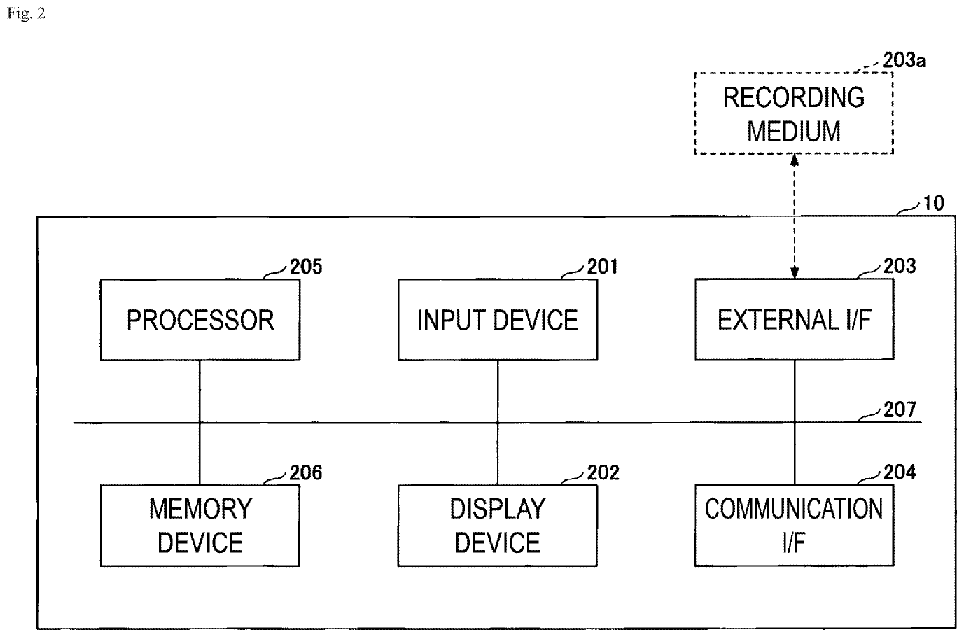

Next, a hardware configuration of the spatial data downscaling apparatus 10 according to the present embodiment will be described with reference to FIG. 2. FIG. 2 is a diagram illustrating an example of the hardware configuration of the spatial data downscaling apparatus 10 according to the present embodiment.

As illustrated in FIG. 2, the spatial data downscaling apparatus 10 according to the present embodiment is implemented by a general computer or a computer system, and includes an input device 201, a display device 202, an external I/F 203, a communication I/F 204, a processor 205, and a memory device 206. These hardware components are communicably connected via a bus 207.

The input device 201 is, for example, a keyboard, a mouse, or a touch panel. The display device 202 is, for example, a display. The spatial data downscaling apparatus 10 may or may not include at least one of the input device 201 and the display device 202.

The external I/F 203 is an interface with an external device. Examples of the external device include a recording medium 203a and the like. The spatial data downscaling apparatus 10 can perform reading from or writing to the recording medium 203a via the external I/F 203. One or more programs that implement respective functional units (the resolution enhancing processing unit 101, the acquisition unit 102, the operation reception unit 103, the output unit 104, and the like) included in the spatial data downscaling apparatus 10, for example, may be stored in the recording medium 203a.

Examples of the recording medium 203a include a compact disc (CD), a digital versatile disk (DVD), a Secure Digital memory card (SD memory card), and a Universal Serial Bus (USB) memory card.

The communication I/F 204 is an interface for connecting the spatial data downscaling apparatus 10 to a communication network. One or more programs that implement respective functional units of the spatial data downscaling apparatus 10 may be acquired (downloaded) from a predetermined server apparatus or the like via the communication I/F 204.

The processor 205 is, for example, various calculation devices such as a central processing unit (CPU) or a graphics processing unit (GPU). Each functional unit included in the spatial data downscaling apparatus 10 is implemented by one or more programs stored in the memory device 206 or the like causing the processor 205 to execute processing.

The memory device 206 is, for example, any storage device such as a hard disk drive (HDD), a solid state drive (SSD), a random access memory (RAM), a read only memory (ROM), or a flash memory. Each storage unit (the point data storage unit 111, the region data storage unit 112, the parameter storage unit 113, the target division storage unit 114, and the like) included in the spatial data downscaling apparatus 10 can be implemented by using the memory device 206. For example, at least one of the point data storage unit 111, the region data storage unit 112, and the target division storage unit 114 may be implemented by using, for example, a storage device (for example, a database server) connected to the spatial data downscaling apparatus 10 via a communication network.

The spatial data downscaling apparatus 10 according to the present embodiment can implement parameter estimation processing and spatial data resolution enhancing processing to be described below by having the hardware configuration illustrated in FIG. 2. The hardware configuration illustrated in FIG. 2 is an example, and the spatial data downscaling apparatus 10 may have another hardware configuration. For example, the spatial data downscaling apparatus 10 may include a plurality of processors 205 or may include a plurality of memory devices 206.

Flow of Parameter Estimation Processing

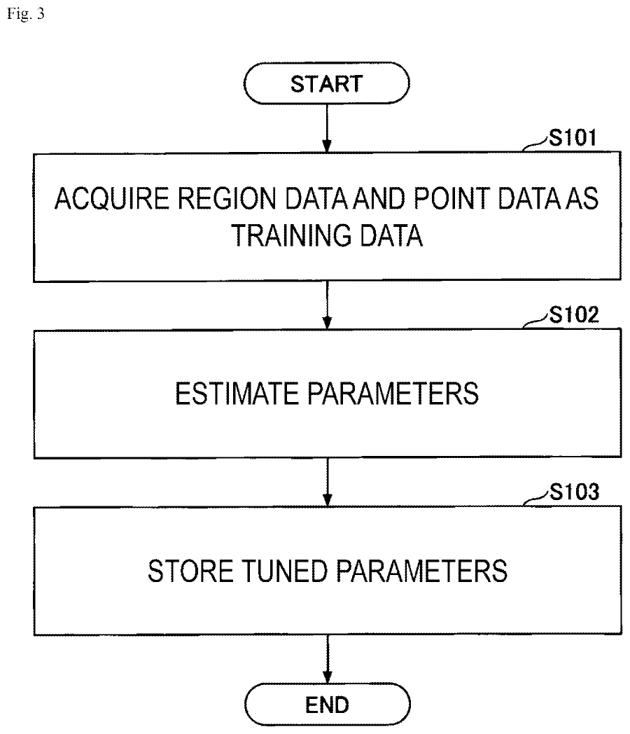

Next, a flow of parameter estimation processing for estimating the parameters of the multivariate Gaussian process model will be described with reference to FIG. 3. FIG. 3 is a flowchart illustrating an example of the parameter estimation processing according to the present embodiment.

First, the acquisition unit 102 acquires the point data and the region data as training data from the point data storage unit 111 and the region data storage unit 112 (step S101).

Next, the parameter estimation unit 105 of the resolution enhancing processing unit 101 maximizes the marginal likelihood shown in Equation (15) above with the training data acquired in step S101 as the observation y to estimate the parameters of the S variate Gaussian process model (step S102). If a plurality of types of point data and region data in a plurality of cities are acquired as training data as described above, the parameter estimation unit 105 of the resolution enhancing processing unit 101 maximizes the marginal likelihood shown in Equation (21) above to estimate the parameters of the S variate Gaussian process model.

The parameter estimation unit 105 of the resolution enhancing processing unit 101 stores various parameters estimated (trained) in step S102 above in the parameter storage unit 113 (step S103).

Flow of Spatial Data Resolution Enhance Processing

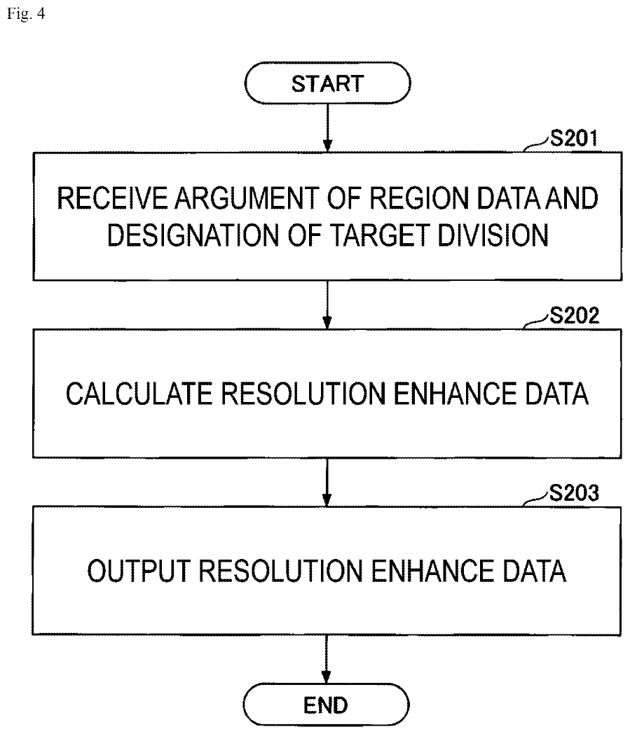

Next, a flow of the spatial data resolution enhancing processing for calculating the resolution enhance data to be obtained by enhancing the resolution of the target type of region data will be described with reference to FIG. 4. FIG. 4 is a flowchart illustrating an example of the spatial data resolution enhancing processing according to the present embodiment.

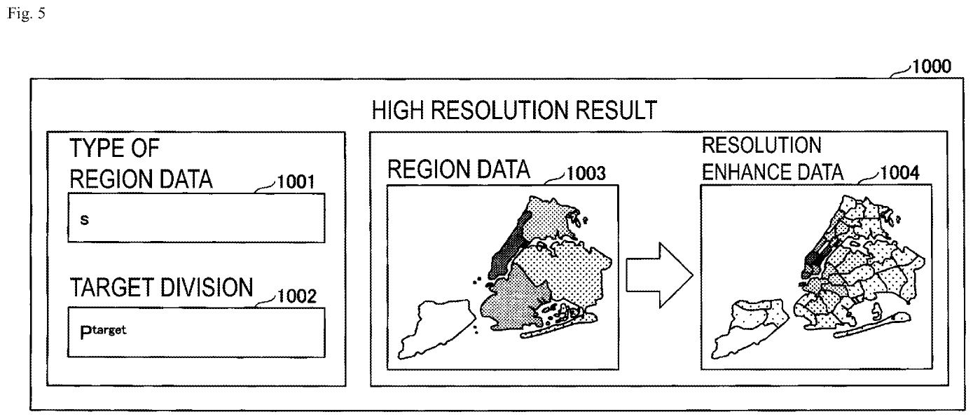

First, the operation reception unit 103 receives a user operation for designating the type s of target region data and the target division P^{target} (step S201). Here, for example, the user can input or select a desired type s and a desired target division P^{target} in a region data type designation field 1001 and a target division designation field 1002 included in a spatial data resolution enhance screen 1000 illustrated in FIG. 5 to designate the division. In the region data display field 1003 included in the spatial data resolution enhance screen 1000 illustrated in FIG. 5, for example, a region included in each item of region data of the type s designated in the region data type designation field 1001 is displayed using a color (or a shade of a color, or the like) according to the value associated with the region.

Next, the resolution enhance data calculation unit 106 of the resolution enhancing processing unit 101, with the type s designated in step S201 and the target division P^{target}, calculates the resolution enhance data with the S variate Gaussian process model in which the parameters (i.e., trained parameters) stored in the parameter storage unit 113 have been set (step S202). That is, the resolution enhance data calculation unit 106 calculates the resolution enhance data obtained by enhancing the resolution of the region data of the type s into the region R^{target} included in the target division P^{target} using Equations (29) to (31) above.

The output unit 104 outputs the resolution enhance data calculated in step S202 above (step S203). For example, the output unit 104 displays a region included in the resolution enhance data calculated in step S202 above in the resolution enhance data display field 1004 included in the spatial data resolution enhance screen 1000 illustrated in FIG. 5 using color (or shade of color, or the like) according to the value (predicted value) associated with the region. Thus, it is possible to visualize the target type of region data and the resolution enhance data obtained by enhancing the resolution of this region data, and the user can narrow down, for example, regions with a high degree of poverty or regions with a higher degree of air pollution in detail and take more detailed measures.

Conclusion

As described above, the spatial data downscaling apparatus 10 according to the present embodiment estimates the parameters of the multivariate Gaussian process model that takes the spatial correlation between a point and a point, between a point and a region, and between a region and a region into account when spatial data including point data and region data is given. That is, the spatial data downscaling apparatus 10 according to the present embodiment sets the “spatial scale parameter,” the “mixing coefficient,” the “residual variance parameter,” and the “noise variance parameter” as unknown quantities, and by using the maximum likelihood estimation, estimates the unknown quantities of the Gaussian process model from the region data and the point data. This estimation is performed by representing the value of the region data using the realization value of the Gaussian distribution having the integrated value of the Gaussian process in the region as an average based on a multivariate Gaussian process model represented by a linear combination of a plurality of latent Gaussian processes, and representing the value of the point data using the realization value of the Gaussian distribution having the value of the Gaussian process at the point as an average.

Thus, the spatial data downscaling apparatus 10 according to the present embodiment brings effects shown in the following (1) to (3).

(1) By modeling a plurality of items of spatial data at the same time based on the multivariate Gaussian process model represented by the linear combination of a plurality of latent Gaussian processes, “spatial scale parameters” can be shared among the plurality of items of spatial data and trained. Thus, even if there is low-resolution spatial data, a plurality of items of spatial data can be effectively utilized to calculate (predict) the resolution enhance data.

(2) If there is spatial data in a plurality of cities (that is, a plurality of entire spaces), by modeling a plurality of items of spatial data at the same time based on the multivariate Gaussian process model represented by the linear combination of a plurality of latent Gaussian processes, “spatial scale parameters” and the “mixing coefficient” can be shared among the plurality of cities and the plurality of items of spatial data and trained. Thus, even if the number of types of spatial data in a certain city is small, spatial data of other cities is effectively utilized to calculate the resolution enhance data.

(3) By representing the value of the region data using the realization value of the Gaussian distribution having the integrated value of the Gaussian process in the region as an average, and representing the value of the point data using the realization value of the Gaussian distribution having the value of the Gaussian process at the point as an average, the spatial correlation between a point and a point, a point and a region, and a region and a region can be accurately evaluated while regions having various sizes or shapes are taken into account, and estimation of unknown quantities of the Gaussian process model can be accurately performed.

The present invention is not limited to the specific embodiment described above, and various modifications or changes, combinations with known technologies, and the like can be made without departing from the description of the claims.

### REFERENCE SIGNS LIST

10 Spatial data downscaling apparatus
101 Resolution enhancing processing unit
102 Acquisition unit
103 Operation reception unit
104 Output unit
105 Parameter estimation unit
106 Resolution enhance data calculation unit
111 Point data storage unit
112 Region data storage unit
113 Parameter storage unit
114 Target division storage unit

1. A spatial data downscaling method executed by a computer including a memory and a processor, the method comprising:
acquiring point data where a point in a geographical space and a value at the point are associated with each other and region data in which a region in the geographical space and a value in the region are associated with each other as training data;
estimating, with the training data acquired in the acquiring, parameters of a multivariate Gaussian process model represented by a linear mixture of a plurality of latent Gaussian processes; and
calculating resolution enhance data in which a region having a finer granularity than the region and a value in the region having the finer granularity are associated with each other from the region data designated by a user with the multivariate Gaussian process model in which the parameters estimated in the estimating have been set.

2. The spatial data downscaling method according to claim 1, wherein the estimating includes estimating a spatial scale parameter, a mixing coefficient, a residual variance parameter, and a noise variance parameter as the parameters of the multivariate Gaussian process model.

3. The spatial data downscaling method according to claim 1, wherein the estimating comprises representing a value of the region data using a realization value of a Gaussian distribution having an integrated value of a Gaussian process in the region as an average based on the multivariate Gaussian process model, representing a value of the point data using a realization value of a Gaussian distribution having a value of a Gaussian process at the point as an average, and estimating the parameters by maximum likelihood estimation.

4. The spatial data downscaling method according to claim 1, wherein the geographical space includes a plurality of geographical spaces representing a plurality of different cities.

5. A spatial data downscaling apparatus comprising:
a memory; and
a processor configured to execute
acquiring point data where a point in a geographical space and a value at the point are associated with each other and region data in which a region in the geographical space and a value in the region are associated with each other as training data;
estimating, with the training data acquired in the acquiring, parameters of a multivariate Gaussian process model represented by a linear mixture of a plurality of latent Gaussian processes; and
calculating resolution enhance data in which a region having a finer granularity than the region and a value in the region having the finer granularity are associated with each other from the region data designated by a user with the multivariate Gaussian process model in which the parameters estimated in the estimating have been set.

6. A non-transitory computer-readable recording medium having computer-readable instructions stored thereon, which when executed, cause a computer including a memory and a processor to execute a method comprising:
acquiring point data where a point in a geographical space and a value at the point are associated with each other and region data in which a region in the geographical space and a value in the region are associated with each other as training data;
estimating, with the training data acquired in the acquiring, parameters of a multivariate Gaussian process model represented by a linear mixture of a plurality of latent Gaussian processes; and
calculating resolution enhance data in which a region having a finer granularity than the region and a value in the region having the finer granularity are associated with each other from the region data designated by a user with the multivariate Gaussian process model in which the parameters estimated in the estimating have been set.
